(19) United States
(12) Patent Application Publication
(10) Pub. No.: US 2009/0294359 A1
(43) Pub. Date: Dec. 3, 2009

(54) PRIMING SYSTEM AND METHOD USING PUMPING AND GRAVITY

(75) Inventors: Peter Hopping, Tampa, FL (US); Steve J. Lindo, Chicago, IL (US); Alexander Braun, Milwaukee, WI (US)

Correspondence Address: K&L Gates LLP, P.O. Box 1135, Chicago, IL, 60690-1135, US

(73) Assignees: BAXTER INTERNATIONAL INC., Deerfield, IL (US); BAXTER HEALTHCARE S.A., Zurich (CH)

(21) Appl. No.: 12/132,461

(22) Filed: Jun. 3, 2008

(51) Int. Cl. B01D 61/34; B01D 61/26; B01D 61/28; B01D 61/32

(52) U.S. Cl. 210/646; 210/141; 210/137

(57) ABSTRACT

A dialysis system includes a pump actuator; a disposable cassette having a pump chamber operable with the pump actuator; a patient line connected to the disposable cassette and in fluid communication with the pump chamber; and a logic implementor configured to prime the patient line according to a sequence in which (i) the pump actuator activates the pump chamber to partially prime the patient line and (ii) a remainder of the patient line is primed via gravity.

### BACKGROUND

The examples discussed below relate generally to medical fluid delivery. More particularly, the examples disclose priming systems and methods for automated peritoneal dialysis (“APD”).

Due to various causes, a person's renal system can fail. Renal failure produces several physiological derangements. The balance of water, minerals and the excretion of daily metabolic load is no longer possible and toxic end products of nitrogen metabolism (urea, creatinine, uric acid, and others) can accumulate in blood and tissue.

Kidney failure and reduced kidney function have been treated with dialysis. Dialysis removes waste, toxins and excess water from the body that would otherwise have been removed by normal functioning kidneys. Dialysis treatment for replacement of kidney functions is critical to many people because the treatment is life saving.

One type of kidney failure therapy is peritoneal dialysis, which uses a dialysis solution, also called dialysate, which is infused into a patient's peritoneal cavity via a catheter. The dialysate contacts the peritoneal membrane of the peritoneal cavity. Waste, toxins and excess water pass from the patient's bloodstream, through the peritoneal membrane and into the dialysate due to diffusion and osmosis, i.e., an osmotic gradient occurs across the membrane. The spent dialysate is drained from the patient, removing waste, toxins and excess water from the patient. This cycle is repeated.

There are various types of peritoneal dialysis therapies, including continuous ambulatory peritoneal dialysis (“CAPD”), automated peritoneal dialysis (“APD”), tidal flow dialysate and continuous flow peritoneal dialysis (“CFPD”). CAPD is a manual dialysis treatment. Here, the patient manually connects an implanted catheter to a drain, allowing spent dialysate fluid to drain from the peritoneal cavity. The patient then connects the catheter to a bag of fresh dialysate, infusing fresh dialysate through the catheter and into the patient. The patient disconnects the catheter from the fresh dialysate bag and allows the dialysate to dwell within the peritoneal cavity, wherein the transfer of waste, toxins and excess water takes place. After a dwell period, the patient repeats the manual dialysis procedure, for example, four times per day, each treatment lasting about an hour. Manual peritoneal dialysis requires a significant amount of time and effort from the patient, leaving ample room for improvement.

Automated peritoneal dialysis (“APD”) is similar to CAPD in that the dialysis treatment includes drain, fill, and dwell cycles. APD machines, however, perform the cycles automatically, typically while the patient sleeps. APD machines free patients from having to manually perform the treatment cycles and from having to transport supplies during the day. APD machines connect fluidly to an implanted catheter, to a source or bag of fresh dialysate and to a fluid drain. APD machines pump fresh dialysate from a dialysate source, through the catheter, into the patient's peritoneal cavity, and allow the dialysate to dwell within the cavity, and allow the transfer of waste, toxins and excess water to take place. The source can be multiple sterile dialysate solution bags.

APD machines pump spent dialysate from the peritoneal cavity, though the catheter, to the drain. As with the manual process, several drain, fill and dwell cycles occur during dialysate. A “last fill”occurs at the end of CAPD and APD, which remains in the peritoneal cavity of the patient until the next treatment.

Both CAPD and APD are batch type systems that send spent dialysis fluid to a drain. Tidal flow systems are modified batch systems. With tidal flow, instead of removing all of the fluid from the patient over a longer period of time, a portion of the fluid is removed and replaced after smaller increments of time.

Continuous flow, or CFPD, systems clean or regenerate spent dialysate instead of discarding it. The systems pump fluid into and out of the patient, through a loop. Dialysate flows into the peritoneal cavity through one catheter lumen and out another catheter lumen. The fluid exiting the patient passes through a reconstitution device that removes waste from the dialysate, e.g., via a urea removal column that employs urease to enzymatically convert urea into ammonia. The ammonia is then removed from the dialysate by adsorption prior to reintroduction of the dialysate into the peritoneal cavity. Additional sensors are employed to monitor the removal of ammonia. CFPD systems are typically more complicated than batch systems.

In any of the above types of PD, it is important not to pump or deliver air to the patient. Accordingly, the liquid carrying portion of the dialysis system (e.g., pumping cassette and fluid lines for APD) needs to be purged of air (primed with dialysis fluid) prior to connection of the fluid carrying portion to the patient. This Home Choice® system marketed by the assignee of the present disclosure uses a gravity prime system to prime the patient line. Here, during setup of the system primes the patient line by connecting a heater bag to the patient line. As long as the patient line is at the same level of the heater bag, fluid flows from the heater bag to the patient line until the level of fluid in the patient line is equal to the level of fluid in the heater bag. Accordingly, the heater bag location and the end of the patient line need to be fixed to prime successfully.

In the HomeChoice® system, the patient needs to ensure that the patient line has been primed properly. Also, the HomeChoice® system operates with a batch heater having a heater pan at the top of the machine. It is desirable to have a priming system that automatically ensures that the patient line has been primed properly. It is also desirable to have a priming system that is not limited to batch heating or that restricts the heater to having to be located at a particular location.

### SUMMARY

The present priming system and method are operable with batch or in-line heating. That is, the dialysis machine can operate without a heater bag. Further, the supply bags can be placed in any location allowed by supply bag line length, e.g., below the dialysis machine. The system does not require the distal end of the patient line to be positioned relative to the heater, providing flexibility to the heater and disposable configuration.

The present system and method in one embodiment operates with a disposable cassette. The cassette includes one or more pump chamber. The dialysis machine has one or more pump actuator that actuates the one or more pump chamber. The pump actuator can be a pneumatic pump actuator, which tracks the volume of fluid pumped via a method based on the Ideal Gas Law.

The disposable cassette connects fluids to a plurality of containers or bags, such as supply bags, a drain bag and possibly a heater bag (for batch heating). The disposable cassette can include or connect to an in-line fluid heater. Further, the disposable cassette connects fluidly to a patient line, which is eventually connected to the patient for treatment.

The cassette further includes valve chambers operated by valve actuators provided by the dialysis instrument. The valve actuators can also be pneumatic pump actuators. The system also employs a volumetric control device, which controls the amount of dialysis fluid pumped to and from the patient and an amount of ultrafiltration removed from the patient. The volumetric control device can for example operate using the Ideal Gas Law.

The supply lines are primed using fresh dialysate from the bags to which the supply lines are connected. The drain line does not need to be primed. The heater line(s) if used is/are primed using fresh dialysate from one of the supply bags. The patient line is primed via the following sequence.

In a first portion of the priming sequence, the one or more pump actuator causes the one or more pump chamber to pump dialysis fluid through a majority of the patient line, e.g., seventy-five percent. The patient is instructed to connect a distal end of the patient line to a holding apparatus, such that the distal end is located at a same elevation as the top of the pump chambers when the cassette is loaded into the dialysis machine. In a second portion of the priming sequence, the relevant valve actuators and valve chambers are switched automatically so that fresh dialysis fluid is allowed to gravity prime the remainder of the patient line, e.g., the final twenty-five percent. The gravity prime fills the patient line to the top of its distal end, which is aligned with the top of one or more of the pump chambers.

In both the first and second portions of the priming sequence, the volumetric control device measures the amount of dialysis fluid pumped or fed to the patient line. The internal volume of the patient line is known, so that a comparison between known volume and actual volume of fluid delivered can be made to see if the actual volume is within an acceptable margin of error. Thus the patient is not forced to check to see if the patient line has been primed fully. Also, the priming sequence is automated once the distal end of the patient line is connected to the holding apparatus.

The patient line is pump primed and gravity primed with dialysis fluid from one of the pump chambers fed via a heater line (in-line or batch) in one embodiment. Alternatively, the patient line is pump primed and gravity primed with dialysis fluid from one of the pump chambers fed via one of the supply bags/lines.

It is accordingly an advantage of the dialysis system and method of the present disclosure to have an automated priming sequence.

It is another advantage of the dialysis system and method of the present disclosure to have a priming sequence that does not require the patient to check if priming has been performed properly.

It is still a further advantage of the dialysis system and method of the present disclosure to have a priming sequence that is independent of the placement of the supply and heater bags.

It is yet another advantage of the dialysis system and method of the present disclosure to have a priming sequence operable with an in-line heater.

Additional features and advantages are described herein, and will be apparent from the following Detailed Description and the figures.

### BRIEF DESCRIPTION OF THE FIGURES

FIG. 1 is a perspective view of one embodiment of a dialysis system having a priming sequence according to the present disclosure.

FIG. 2 is a perspective view of one embodiment of a disposable cassette operable with the dialysis system having a priming sequence according to the present disclosure.

FIG. 3 is a side-sectioned view showing one embodiment for a pneumatic operation of one of the pumping chambers.

FIG. 4 is a schematic view illustrating one embodiment for alignment of the distal end of the patient line relative to the one or more dialysis fluid pump chamber.

FIG. 5 is an elevational view of an outside of the dialysis machine and one embodiment for the patient line distal end holding apparatus of the present disclosure.

FIG. 6 is a schematic view of one embodiment of the pneumatic pump and valve control architecture for the system of the present disclosure.

### DETAILED DESCRIPTION

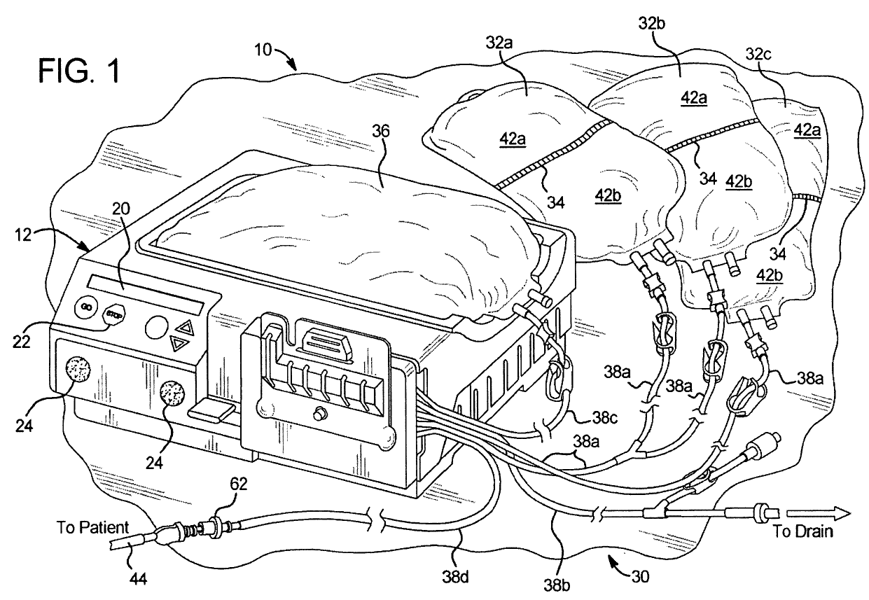

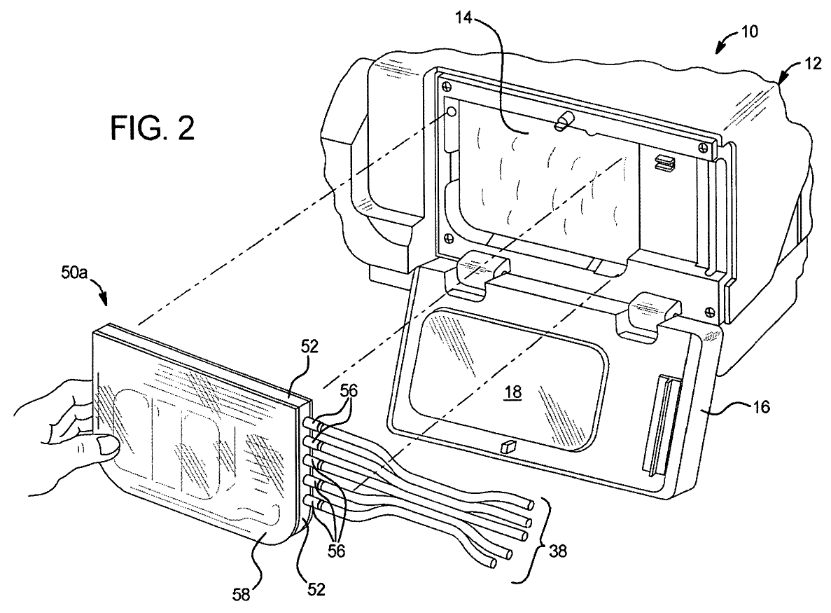

Referring now to the drawings and in particular to FIGS. 1 to 2, a renal failure therapy system 10 is provided. System 10 is applicable generally to any type of renal failure therapy system, such as peritoneal dialysis (¢PD”), hemodialysis (“HD”), hemofiltration (“HF”), hemodiafiltration (“HDF”) and continuous renal replacement therapy (“CKKI ”). System 10 could also be used outside of the renal field, such as for medication delivery and other blood processing applications. For ease of illustration, however, system 10 is described as a dialysis system, and in one particularly well-suited application, as an APD system.

System 10 in the illustrated embodiment includes a dialysis instrument 12. Dialysis instrument 12 is configured for whichever type of renal failure therapy system is used. Dialysis instrument 12 includes a central processing unit (“CPU”) and a plurality of controllers (e.g., safety, valve, heater, pump, video and audio (e.g., voice guidance) controllers) operable with the CPU. CPU operates with a graphical user-machine interface (“GUI”), e.g., via the video controller. The GUI includes a video monitor 20 and one or more type of input device 22, such as a touch screen or electromechanical input device (e.g., membrane switch).

The CPU and video controller in cooperation with video monitor 20 provide automated priming instructions and confirmation to the patient or caregiver visually via characters/graphics. For example, characters/graphics can be displayed to (i) provide instructions regarding placement of a distal end of the patient line onto instrument 12 (discussed below) for priming and/or (ii) inform the patient when the patient line has been primed fully. Additionally or alternatively, the CPU and voice guidance controller in cooperation with speakers 24 provide (i) and/or (ii) listed above.

As seen in FIG. 1, dialysis instrument 12 accepts and operates with a disposable set 30. Disposable set 30 includes one or more supply bag 32a to 32c (referred to herein collectively as supply bags 32 or individually, generally as supply bag 32), shown here as dual-chamber supply bags separating two fluids via a peel or frangible seal 34. Disposable set 30 also includes a drain bag (not illustrated), a warmer bag 36, bag, and drain, warmer bag and patient tubes 38a to 38d, respectively (referred to herein collectively as tubing or tubes 38 or individually, generally as tube 38) and a disposable pumping/valve cassette 50a (FIG. 2).

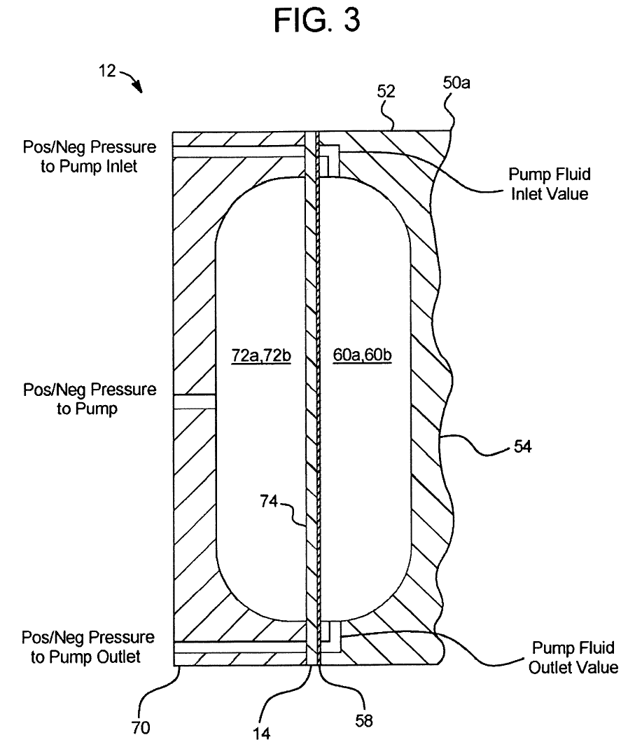

Warmer bag 36 is used in a batch heating operation in which the top of instrument 12 batch heats fluid within bag 36. One advantage of the priming method of system 10 is that disposable set 30 can operate alternatively with an inline heater (discussed further in FIG. 3), in which case warmer bag 36 is not needed. It is important to note, however, that the priming method of system 10 can operate with a warmer bag and that the warmer bag can be placed in any desired position, that is, it is not required that the bag be placed on top of instrument 12 to provide an elevated volume of heated dialysate for gravity priming as is done in the HomeChoice® APD system marketed by the assignee of the present disclosure. System 10 can also pump spent fluid to a house drain, such as a bathtub, a toilet or sink, instead of to a drain bag, in which case the drain bag is not needed.

While three supply bags 32 are shown, system 10 can employ any suitable number of supply bags. Supply bags 32 are shown having multiple chambers 42a and 42b, separated by frangible seal 34, which hold different solutions depending on the type of therapy employed. For example, chambers 42a and 42b can hold buffer and glucose for PD or acetate and bicarbonate solution for HD. Supply bags 32 are alternatively single chamber bags, which hold a single premixed solution, such as premixed PD or HD dialysate.

As seen in FIGS. 1 to 3, a disposable cassette 50a connects to supply bags 32, drain bag and warmer bag 36 via tubes 38a, 38b and 38c, respectively. Tube 38d runs from cassette 50a to a patient connection 44. Cassette 50a in one embodiment includes a rigid structure having rigid outer walls 52 and a middle, base wall 54 from which pump chambers (60a and 60b as shown in FIG. 3), valve chambers (e.g., volcano valve chambers) and rigid fluid pathways extend. Rigid fluid ports 56 extend from a side wall 52 and communicate fluidly with the rigid cassette pathways and connect sealingly to tubing 38. Tubing 38 can be fixed to ports 56, in which case the bags 32 are spiked to allow fluid from the bags to flow through tubing 38 into cassette 50a. Alternatively, tubing 38 is fixed to bags 32, in which case ports 56 are spiked to allow fluid from the bags 32 and tubing 38 into cassette 50a.

A pair of flexible membranes or sheets 58 is sealed to outer rigid walls 52 of the cassette. Cassette 50a is sealed within instrument 12 such that sheeting 58 forms the outer surfaces of the rigid fluid pathways of the cassette. One of the sheets is moved to pump fluid through pump chambers (60a and 60b) and to open and close the cassette valves.

Instrument 12 can actuate the pump and valve chambers of cassette 50a pneumatically, mechanically or both. The illustrated embodiment uses pneumatic actuation. The HomeChoice® APD system uses a pneumatic system described in U.S. Pat. No. 5,350,357 (“the '357 Patent”), the entire contents of which are incorporated herein by reference. As seen in FIGS. 2 and 3, instrument 12 includes a flexible membrane 14, which creates different sealed areas with cassette sheeting 58 at each of the pump and valve chambers of cassette 50a. Membrane 14 moves with the sheeting 58 in those areas to either open/close a valve chamber or pump fluid through (into and out of) a pump chamber. An interface plate 70 is located behind membrane 14 and includes first and second chamber halves 72a and 72b that mate with chamber halves 60a and 60b of cassette 50a to form a pair of fixed volume pump chambers (60a and 72 or 60b and 72b discussed in detail in the '357 Patent).

Instrument 12 in the illustrated embodiment includes a door 16, which closes against cassette 50a. Door 16 includes a press plate 18, which can be operated mechanically (e.g., via the closing of the door) and/or pneumatically (e.g., via an inflatable bladder located in the door behind the press plate). Pressing plate 18 against cassette 50a in turn presses cassette 50a against pumping membrane 14, which cooperates with sheeting 58 of cassette 50a to pump fluid through chambers 60a and 60b and to open and close the cassette valve chambers.

The cassette interface plate 70 is located behind membrane 14. Cassette interface plate 70 is configured to apply positive or negative pressure to the cooperating membrane 14 and cassette sheeting 58 at the different valve and pump areas. For example, positive pressure is applied to membrane 14/sheeting 58 at areas 74 of the membrane/sheeting located within the internal walls of cassette 50a that define pump chambers 60a and 60b to push fluid out of the pump chambers and within chamber halves 72a, 72b of interface plate 70. Negative pressure is applied to membrane 14/sheeting 58 at those same areas 74 to pull fluid into the pump chambers. Likewise, positive pressure is applied to membrane 14/sheeting 58 at areas 76 of the sheeting within the internal walls of cassette 50a and interface plate 70 defining the valve chambers to close outlet ports of the valve chambers. Negative pressure is applied to membrane 14/sheeting 58 at those same areas 76 to open the outlets of the valve chambers.

U.S. Pat. No. 6,814,547 (“the '547 patent”) assigned to the assignee of the present disclosure, discloses a pumping mechanism in connection with FIGS. 17A and 17B and associated written description, incorporated herein by reference, which uses a combination of pneumatic and mechanical actuation. FIGS. 15, 16A and 16B of the '547 Patent and associated written description, incorporated herein by reference, teach the use of mechanically actuated valves. One or both of these mechanisms can be used instead of the purely pneumatic system of the HomeChoice® machine.

The '357 Patent and the '547 patent also teach different systems and methods, incorporated herein expressly by reference, of knowing and controlling the amount of fresh dialysate delivered to the patient, the amount of effluent dialysate removed from the patient, and thus the amount of additional fluid or ultrafiltrate (“UF”) removed from the patient. UF is the blood water that the patient accumulates between treatments due to the patient's failed kidneys. The dialysis treatment removes this blood water as UF in an attempt to bring the patient back to his or her dry weight. Either of the systems and method of the '357 Patent and the '547 patent can be used as described below for the priming method of system 10.

FIG. 1 illustrates that the distal end of patient line 38d includes a connector 62 that is provided initially with a tip protector (not shown). Once patient line 38d is primed, the patient removes the tip protector and connects connector 62 of the patient line to patient connection 44 of the patient's transfer set. Supply lines 38a are either pre-primed (supply bags 32 packaged with supply lines 38a in fluid communication with the bags), in which case cassette 50a is primed by pulling fluid from supply lines 38a (once connected to cassette 50a) and pumping fluid through the cassette, pushing air out drain line 38b and/or patient line 38d. Supply lines 38a are alternatively primed when bags 32 are spiked and dialysate is pumped through the supply lines, pushing air through cassette 50a and out of patient line 38d or drain line 38b. Drain line 38b may or may not be primed, if so, fluid is pumped from one of the supply bags 32, through the cassette 50a, and out drain line 38b. Patient line 38d is primed as follows.

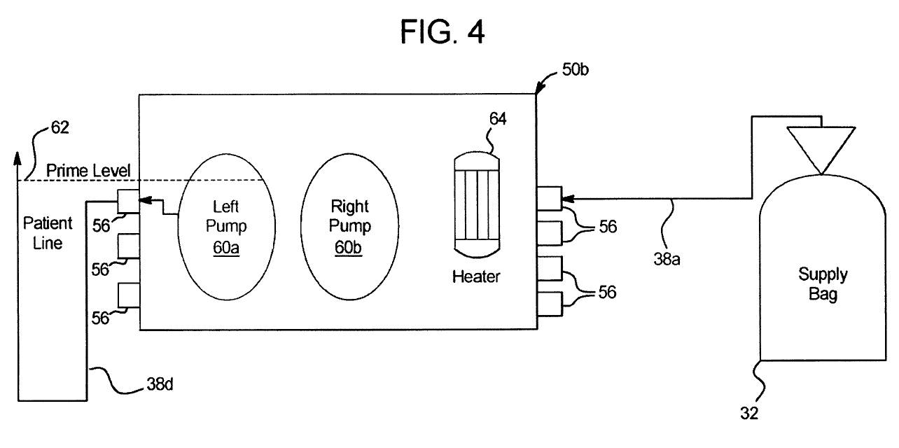

Referring now to FIG. 4, an alternative cassette 50b is illustrated. Cassette 50b includes an inline heating pathway 64, which heats dialysate as it is delivered to the patient as opposed to batch heating dialysate for treatment. Multiple suitable fluid cassettes including inline heating pathways are disclosed in the '547 patent at FIGS. 4A, 5 and 6 and associated written description, incorporated herein by reference. Multiple additional suitable fluid cassettes including inline heating pathways are disclosed in U.S. patent application Ser. No. 11/773,903, entitled “Dialysis Fluid Heating Systems”, filed Jul. 5, 2007, the entire contents of which are incorporated herein by reference.

Cassette 50b, like cassette 50a includes ports 56, certain ones of which connect fluidly to supply bags 32 via supply lines 38a. One of ports 56 connects to patient line 38d. In the priming method of system 10, the patient after loading cassette 50 (referring to either cassette 50a or 50b) into instrument 12 and closing door 16 to seal cassette 50 within the instrument, fixes the distal end connector 62 of patient line 38d onto instrument 12 (FIG. 1), such that the top of the connector 62 is aligned with the top (or near the top) of one or both pump chambers 60a and 60b. Then in an automated priming sequence, instrument 12 actuates one or both pump chambers 60a and 60b to pump fresh dialysate from one of supply bags 32, past fluid heating pathway 64, which heats the fresh dialysate, into a portion of patient line 38d. For example, instrument 12 can actuate one or both pump chambers 60a and 60b to pump fresh, heated dialysate to fill approximately seventy-five percent of patient line 38d.

In a next portion of the priming method of system 10, one of the pump chambers, e.g., left pump chamber 60a is filled with fresh dialysate. Then, the appropriate valve chamber(s) of cassette 50b is/are opened to allow fresh dialysate to gravity prime the remainder of patient line 38d. Gravity priming the remaining portion of patient line 38d allows the line to be primed fully without overfilling the line assuming proper alignment of connector 62 and pump chamber 60a is achieved.

As seen at FIG. 3, the cassette interface plate 70 located within instrument 12 defines a portion 72a, 72b of the overall pump chamber. Sheeting 58 of cassette 50 is pulled into that interface portion 72a, 72b via negative pressure to pull dialysate into the pump chamber 60a, 60b of cassette 50. Thus when pump chamber 60a for example is full of fluid, cassette sheeting 58 actually bulges outwardly from the side of the cassette. When (i) the negative pressure is removed from the interface plate pump chamber portion and (ii) the valve to the patient line is opened, the sheeting 58 moves inward towards wall 54 of pump chamber 60a as the amount of dialysate leaves pump chamber 60a via gravity to completely prime patient line 38d. In this manner, (i) air does not enter pump chamber 60a as fluid leaves via gravity and (ii) fluid does not need to be supplied to pump chamber 60a to make up for the fluid that leaves the pump chamber. It is desireable that sheeting 58 not stretch enough to cause an extra amount of fluid to be primed beyond what gravity alone produces.

In one embodiment therefore, the amount of fluid that needs to be gravity fed to complete the priming of patient line 38d is equal to or less than the volume defined by the portion 72a, 72b of the pump chamber carved out into the cassette interface plate 70 of machine 12. In one example, assume the volume of the pump chamber of the cassette interface plate is 5 cm³ (0.305 in³) and the inner diameter of the patient line is 0.156 in³, and knowing the volume of the cylinder tubing is V=πr²h, then the pump chamber has the capacity to prime the final 15.97 inches worth of tubing. Then, if the total patient line length is ten feet, instrument 12 needs to actively pump at least 104.03 inches (120 inches-15.97 inches) worth of fluid into the patient line. Using V=πr²h again results in an actively pumped volume of about 1.99 in³ or 32.6 mL of fresh dialysate. As should be apparent from this example, the length and inner diameter of patient line 38d are programmed into the CPU (or sub-controller) of instrument 12 in one embodiment.

The volumetric control system (e.g., of the '357 Patent or the '547 Patent incorporated above) ensures the desired amount (e.g., 33 mL) of fluid is pumped to the patient line in the prime sequence. That same system also measures the volume of fluid gravity primed into patient line 38d. For example, the flow management system (“FMS”) of the '357 Patent measures pressure on the air side 72a, 72b of the cassette pumping membrane 14/sheeting 58, converts a pressure change taken on the air side 72a, 72b of the membrane sheeting to a volume change using the Ideal Gas Law, and calculates the fluid volume leaving the cassette under gravity, knowing the volume change on the air side of the membrane and the total overall volume of the reference air chamber.

Thus, instrument 12 can be programmed to add the two fluid volumes (pumped and gravity fed), to know the total volume of patient line 38d, and to compare the combined volumes to the known tube volume to see if they match. If the volumes match (or are within an acceptable error), instrument 12 informs the patient that priming is complete via one of the GUI mechanisms discussed above. If not, instrument 12 informs the patient to inspect the patient line to see if it is primed properly. If so, patient presses an appropriate input device 22 so that treatment can continue. If not, system 10 instructs the patient to perform a procedure to prime the patient line properly. In one embodiment, treatment cannot continue until the system 10 knows (calculates or is told) that the patient line has been primed properly.

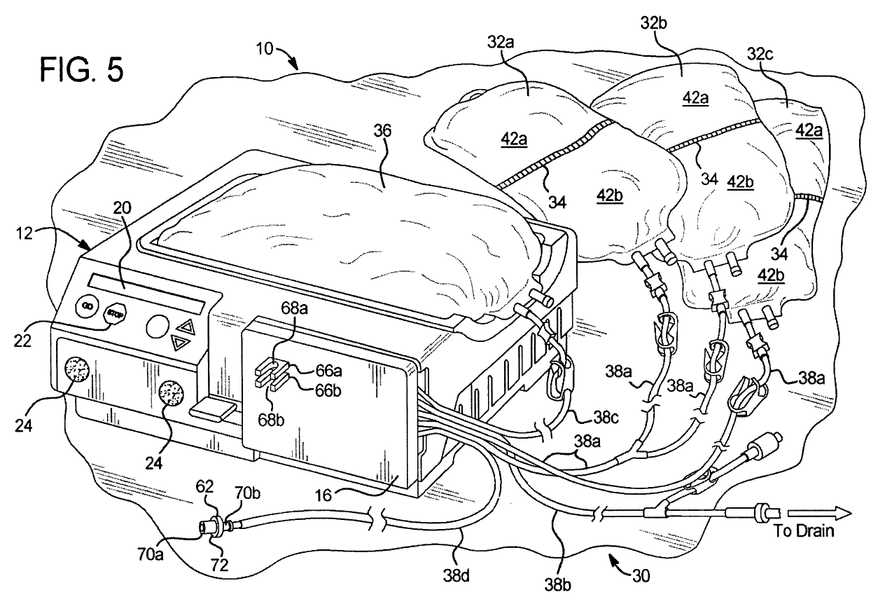

FIG. 5 illustrates that door 16 of instrument 12 in one embodiment provides upper and lower snap-fitting apparatuses 66a and 66b, respectively, which hold distal patient line connector 62 at the proper elevation relative to the top of pumping chamber 60a (and possibly chamber 60b). Apparatuses 66a and 66b are intuitive, such that the patient can easily recognize where patient line connector 62 should be placed. Different diameter U-shaped slot openings 68a and 68b match different diameter tube sections 70a and 70b of connector 62, making improper placement of connector 62 onto door 16 of instrument 12 difficult. Slot openings 68a and 68b snap-fit about tube sections 70a and 70b to hold connector 62 in place firmly. Apparatuses 66a and 66b are spaced apart from one another to allow a flange 72 of connector 62 to fit snugly between the apparatuses 66a and 66b, further holding connector 62 to instrument 12 and making improper placement of connector 62 onto door 16 of instrument 12 difficult.

In one embodiment, one or both of apparatuses 66a and 66b is provided with a sensor, such as a proximity sensor or a light emitter/receiver sensor, that detects the presence of distal end connector 62. The sensor could be located alternatively on door 16, behind apparatuses 66a and 66b. When the patient snaps connector 62 into apparatuses 66a and 66b, the sensor detects the presence of the connector, and sends a signal to the CPU to allow the automated priming sequence to begin. It is also contemplated to code connector 62 with a marking indicative of the length and inner diameter of the corresponding patient line 38d, so that instrument 12 pumps the right amount of partial prime to the patient line. The marking can be a barcode for example or a series of apertures that let a particular pattern of light reach a receiver from a light emitter.

In an embodiment, the GUI of instrument 12 prompts the patient to spike the heater bag (if used) and to remove any line clamps, such as a supply line clamp, heater bag clamp and patient line clamp. Once the patient confirms that all clamps have been removed and that the bags have been opened by pressing one of input devices 22, instrument 12 begins the automated priming sequence by pumping the predetermined amount of partial prime to patient line 38d. Once the pumping portion of the prime is completed, the gravity portion begins automatically.

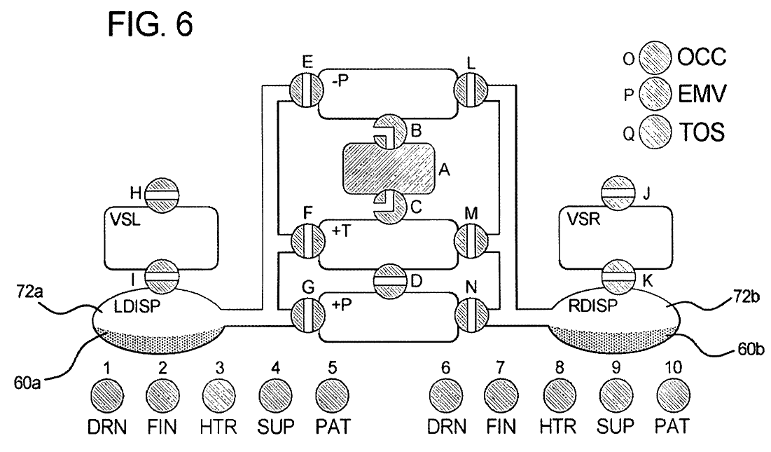

Referring now to FIG. 6, one pneumatic valving and pumping arrangement and sequence for performing the gravity fill portion of the automated priming method of system 10 is illustrated. In the schematic, LDISP and RDISP are the overall pump chambers including chamber portions 60a and 60b of cassette 50 and the carved out chamber portions of 72a, 72b the cassette interface 70. +P and −P are positive and negative pressure sources or tanks, respectively. VSL and VSR are volumetric reference chambers used to perform volumetric fluid control according to the FMS described in the '357 Patent. Letters B to K denote different instrument pneumatic valves, and numbers 1 to 10 denote different disposable fluid valves.

To perform the gravity fill portion of the automatic priming method of system 10, instrument 12 issues a set of commands to negatively pressurize left air chamber 72a with air such that it draws heated fluid into chamber 60a (either from inline heater 64 or from a warmer bag). Valve E is opened allowing negative pressure from −P to pull a vacuum on LDISP, sucking cassette membrane 14/sheeting 58 against the wall of the respective carved-out chamber portion 72a of the cassette interface 70. After the pressure on sheeting 58 is equalized, valve 3 is opened, allowing heated fluid from the heater (bag) to be pulled into pump chamber 60a of LDISP. Left pump chamber 60a of LDISP is filled, e.g., in about two seconds. Valves E and 3 are then closed.

Instrument 12 then issues a set of commands to vent any remaining negative pressure to atmosphere and to allow for atmospheric pressure to be present in the carved-out cassette interface portion 72a of the pump chamber for the gravity prime. Valve I is opened to vent any remaining negative pressure from the air side of LDISP to reference chamber VSL. Reference chamber VSL valve H is opened to vent any negative pressure to atmosphere, so that atmospheric pressure resides behind membrane 14/cassette sheeting 58 for the gravity prime.

Next, instrument 12 causes patient valve 5 to be opened, so that fluid can flow via gravity from left pump chamber 60a of LDISP. The FMS or other volumetric control system records the amount of fluid that gravity flows from pump chamber 60a of LDISP for confirmation purposes discussed above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A dialysis system comprising:
a pump actuator;
a disposable cassette having a pump chamber operable with the pump actuator;
a patient line connected to the disposable cassette and in fluid communication with the pump chamber; and
a logic implementor configured to prime the patient line according to a sequence in which (i) the pump actuator activates the pump chamber to partially prime the patient line and (ii) a remainder of the patient line is primed via gravity.

2. The dialysis system of claim 1, the pump actuator carried by a housing, the housing including an apparatus positioned and arranged to hold the patient line such that a distal end of the patient line is at least substantially at the same elevation as a top of the pump chamber.

3. The dialysis system of claim 2, the distal end of the patient line including an identifier, the holding apparatus including a sensor configured to read the identifier.

4. The dialysis system of claim 2, which includes a valve actuator, the logic implementor configured to cause the valve actuator to allow the pump chamber to be in fluid communication with the patient line when its distal end is held by the apparatus.

5. The dialysis system of claim 4, the valve actuator operable with a valve chamber, the valve chamber located in the disposable cassette.

6. The dialysis system of claim 4, the pump actuator a first pump actuator, the pump chamber a first pump chamber, and which includes a second pump actuator and a second pump chamber located in the cassette, the cassette loaded into the housing such that the first pump chamber is closer to the apparatus then the second pump chamber.

7. The dialysis system of claim 1, the pump actuator a first pump actuator, the pump chamber a first pump chamber, and which includes a second pump actuator and a second pump chamber located in the cassette, portion (i) of the sequence including the first and second pump actuators actuating the first and second pump chambers to partially prime the patient line.

8. The dialysis system of claim 1, wherein at least seventy-five percent of patient line is primed in portion (i) of the sequence.

9. The dialysis system of claim 1, which includes a volumetric control system operable with the pump actuator to know how much dialysis fluid is removed from the pump chamber in at least one of portion (i) and portion (ii) of the sequence.

10. The dialysis system of claim 8, wherein the pump actuator is a pneumatically operated pump actuator and the volumetric control system uses the Ideal Gas Law.

11. The dialysis system of claim 1, which includes at least one of a supply container and an inline heater/heater bag connected fluidly to the disposable cassette, the logic implementor configured to perform at least portion (i) of the sequence using fluid from the supply container or the inline heater/heater bag.

12. The dialysis system of claim 1, which includes a heater line connected fluidly to the disposable cassette, the logic implementor configured to perform at least one of portion (i) and portion (ii) of the sequence using fluid from the heater line.

13. The dialysis system of claim 1, which includes an in-line heater positioned and arranged to heat fluid pumped by the pump actuator.

14. The dialysis system of claim 1, the pump chamber of the disposable cassette formed partially via a flexible sheet, the flexible sheet actuated by the pump actuator for (i), the flexible sheet configured to reduce a compliance force supplied by the flexible sheet for (ii).

15. A dialysis therapy priming method comprising:
pumping dialysis fluid through a portion of a patient line;
stopping the pumping; and
allowing the medical fluid to flow via gravity through a remainder of the patient line.

16. The dialysis therapy priming method of claim 15, which includes urging an alignment of a distal end of the patient line and pumping chamber for the medical fluid.

17. The dialysis therapy priming method of claim 15, which includes confirming that a proper amount of the dialysis fluid has been delivered to the patient line.

18. The dialysis therapy priming method of claim 15, which includes heating the dialysis in-line.

19. A dialysis therapy priming method comprising:
(i) priming dialysis fluid through a first portion of a fluid line;
(ii) allowing the dialysis fluid to be gravity fed through a second portion of the fluid line; and
(iii) determining if a desired priming amount of the dialysis fluid has been delivered to the fluid line via steps (i) and (ii).

20. The dialysis therapy priming method of claim 19, wherein the determining step includes volumetrically measuring an amount of the dialysis fluid delivered via steps (i) and (ii).

21. The dialysis therapy priming method of claim 20, which includes comparing the measured amount to a known internal volume of the fluid line.
